(19) United States
(12) Patent Application Publication
(10) Pub. No.: US 2011/0152019 A1
(43) Pub. Date: Jun. 23, 2011

(54) BELT AND CONICAL PULLEY TRANSMISSION

(75) Inventors: Wolfgang Gantner, Baden-Baden (DE); Marcus Baumann, Karlsruhe (DE); Remi Leorat, Strasbourg (DE); Marcus Junig, Emmenbrucke (CH)

(73) Assignee: SCHAEFFLER TECHNOLOGIES GMBH & CO. KG, Herzogenaurach (DE)

(21) Appl. No.: 12/736,688

(22) PCT Filed: Apr. 27, 2009
(86) PCT No.: PCT/DE2009/000602

§ 371 Date: Feb. 10, 2011

Related U.S. Application Data
(60) Provisional application No. 61/125,883, filed on Apr. 29, 2008.

(51) Int. Cl. F16H 55/56

(52) U.S. Cl. 474/8

(57) ABSTRACT

A belt and conical pulley transmission including pairs of conical pulleys on the drive side and on the driven side, each pair of pulleys including an axially movable and an axially fixed conical pulley. A plate-link chain is disposed between the pulley pairs to transmit torque and includes pressure pieces. A slide rail guides the chain in a chain movement direction and is tiltably supported for tilting movement relative to a support. The slide rail is also movable along the support in a transverse direction relative to the chain movement direction to guide the chain during transmission ratio changes to minimize chain transverse oscillations and consequent acoustic disturbances.

### BACKGROUND OF THE INVENTION

1. Field of the Invention

The present invention relates to a belt and conical pulley transmission including a pair of conical pulleys on the drive- and driven side, each of said pairs having respectively an axially moving and an axially fixed conical pulley, and a plate-link chain for transmitting torque. The chain is disposed between the pairs of conical pulleys and includes pressure pieces. A slide rail is guided tiltably on a support, said slide rail also being moveable largely at right angles to an axial direction of the support, said slide rail including first and second tongues with slide surfaces, said tongues forming a receiving area for receiving the plate-link chain, and said slide rail being disposed axially movably along the support.

2. Description of the Related Art

A belt and conical pulley transmission of the described type can be used for example in motor vehicles and is characterized by a jerk-free and uninterrupted power train transmission. The plate-link chain used here at the same time features pressure pieces that project laterally over the side surfaces formed by the said links of the plate-link chain and transmits the driving torque, for example, coming from an internal combustion engine by means of frictional power between face surfaces of the pressure pieces.

The plate-link chain used as belt-drive means at the same time features a tight- and a slack side, in that transversal oscillation can arise and be perceived to be disturbing because of their proneness to acoustic propagation inside the car and are felt inside the vehicle. Moreover, these transversal oscillations also lead to an increase of the power transmitted by the tight side or slack side and can therefore contribute to a reduction of the service life of the plate-link chains.

In order to solve this problem, a belt and conical pulley transmission has already been disclosed, based on DE 100 17 005 A1, which features a slide rail that further features the first and second tongues that form a receiving area for the plate-link chain. If the plate-link chain now moves into the receiving area of the disclosed slide rail, then physical contact between the under- and/or top side of the plate-link chain with the slide surfaces of the slide rail leads to transversal oscillations no longer being able to propagate within the receiving area and therefore said oscillations that are perceived as acoustically disturbing and reduce the service-life of the plate-link chain can no longer occur.

This slide rail is at the same time guided on a support, of the disclosed belt and conical pulley transmission; such that it can tilt in reaction to a variation of the transmission ratio of the belt and conical pulley, transmission and can tilt largely perpendicularly on the support in an axial direction of the support. In other words, this means that the slide rail can move perpendicularly relative to a stretch that connects midpoints of two neighboring conical pulleys, therefore, the height of the slide rail can change over this imaginary stretch and said rail can also tilt on this support relative to said support, thus it can assume different angular positions relative to this imaginary stretch.

If now transmission ratio variation takes place in the belt and conical pulley transmission, then an axial movement of the respectively axially displaceable conical pulley takes place relative to an axially fixed conical pulley. With this movement of the movable conical pulley, an accompanying axial movement of the plate-link chain takes place relative to a shaft connecting a pair of conical pulleys. This means, in other words, that in case of transmission ratio variation, the rotating plate-link chain not only executes a movement relative to the slide surfaces of the tongues of the slide rail, but also executes a movement transversely to the circulation direction of said plate-link chain.

The support of the plate-link chain is disposed in the interstice between both pairs of conical pulleys and the disclosed slide rail is held on it such that it can exercise the two above-described relative movements, and the plate-link chain, in its circulating movement with simultaneous transmission ratio variation taking place, can execute a movement on the slide surfaces of both tongues transversely to the running direction. Because owing to the transmission ratio variation the respectively movable conical pulley moves, it also moves relatively to the slide rail guided on the support.

In order to avoid a geometric collision of the movable conical pulley with the slide rail, the tongues of the slide rail have corresponding curved cutouts that enable free movement of the conical pulleys relatively to the slide rail.

These cutouts now additionally lead to the fact that surfaces available for attaching the slide surfaces, viewed in the running direction of the plate-link chain, do not remain equal and the plate-link chain sweeps over areas of the cutouts in its movement transversely to its circulation direction and thus transversely to the slide surfaces of the cutouts, which, owing to the cutouts, are no longer equipped with a slide surface.

In these areas, the plate-link chain is no longer guided by the slide rail and the normal forces adjusting between the top- and the underside of the plate-link chain and the respective slide surfaces yet in contact must be supported by these slide surfaces. These slide surfaces are therefore subjected to higher surface pressure whereby the plate-link chain gets in contact with its full surface on the slide surfaces. A consequence of this increased surface pressure is the formation of increased abrasion of these more strongly loaded slide surfaces and hence leads to increased wear.

An object of the present invention is to develop the belt and conical pulley transmission of the described type so that wear on the slide rail can be reduced.

### SUMMARY OF THE INVENTION

The present invention relates to a belt and conical pulley transmission with a drive-side and driven-side pair of conical pulleys with respectively an axially displaceable and axially fixed conical pulley and a plate-link chain featuring pressure pieces for torque transmission, disposed between the pair of conical pulleys and a slide rail guided movably and tiltably on a support and to a great extent perpendicularly to an axial direction of the support, which features slide surfaces with first and second tongues, which form a receiving area for the plate-link chain, wherein the slide rail is disposed axially displaceably on the support.

Due to this intended axial displaceability of the slide rail on the support according to the invention, it is possible that the slide rail can move together with the plate-link chain, thus, it can also execute an axial displacement movement relative to the support and as such a chain-guided slide rail is at disposal, which leads to the plate-link chain during its relative movement within the receiving area of the slide rail not being able to move downwards from the latter transversely to the slide surfaces of the slide rail and hence the slide surfaces move together with the plate-link chain in the transverse direction on the support and therefore a contact surface between the top side and bottom side of the plate-link chain and the respective slide surfaces on the first and second tongues can be reached, which goes up to full-surface contact, thus up to a 100% overlap between the top side and the underside of the plate-link chain and respectively extends to the slide surfaces of the slide rail formed by the tongues.

Therefore during the assembly of the belt and conical pulley transmission according to the invention, if the slide rail is mounted with the slide surfaces on the first and second tongues relative to the plate-link chain, then a contact surface adjusts between the top side and underside of the plate-link chain and the respective slide surfaces, which can be selected according to the respective design requirements, and during the motion of the plate-link chain and a transmission ratio change of the belt and conical pulley transmission according to the invention taking place, the axial displacement of the plate-link chain thereby, when the slide rail according to the invention moves together with the axially displaced plate-link chain and thus the selected overlap is retained or an overlap adjusts, which is at least retained to a greater extent during the circulation movement of the plate-link chain and thus the contact surfaces area between the slide surface of the slide rail and the top side and under side of the plate-link chain mostly remains the same and therefore the contact surfaces on the slide surfaces, even in the case of transmission ratio change of the belt and conical pulley transmission, are subject to the same surface pressure values, and thus, the contact forces between the plate-link chain and the slide surfaces are evenly distributed in place, without stress peaks being locally distributed over the slide surfaces, which lead to increased abrasion of the slide surfaces and hence to increased wear.

According to a further development, the invention provides for the slide rail formed movably by means of a contact with the plate-link chain. In other words, this means that the axial displacement movement of the plate-link chain carries the slide rail along, and for this reason, axial displacement movement of the plate-link chain leads to an axial displacement movement of the slide rail on the support and thus of the slide surfaces.

According to further development of the invention, it is planned that the first and second tongue possesses an largely perpendicular guiding-surface body extending to the slide surface, which is formed for the contact with the plate-link chain such that the contact force adjusting between the plate-link chain and guiding-surface body leads to an axial movement of the slide rail on the support.

If the plate-link chain now experiences an axial displacement due to change of the transmission ratio of the belt and conical pulley transmission according to the invention, then the plate-link chain gets in contact with the respective guiding surface body and moves the slide rail on the support due to this contact with the guiding surface body. This displacement movement leads to the plate-link chain being in further contact with the slide surfaces on the first and second tongues during this movement.

According to a further embodiment of the invention, it is possible that a guiding surface formed on the guiding surface body is complementary to an axial face surface of the pressure pieces. This formation at least to a great extent leads to a full-surface contact with the face surface of the pressure pieces and of the guiding surface on the guiding surface body and therefore a large area is available for axial power transmission from the plate-link chain to the slide rail on the slide rail according to the invention.

Based on the conical surfaces of the conical pulleys formed in the angle, the pressure pieces on the plate-link chains normally possess a complementary angle to the cone angle on the face surfaces. According to a further embodiment of the invention, it is now possible that the guiding surface is formed in a cross-section at an angle to the slide surface. It is thus achieved that the angle between the guiding surface and the slide surface at least essentially corresponds to the angle on the face surface of the pressure pieces and thus at least to a great extent to the cone angle of the conical pulleys.

According to a further alternative formation of the belt and conical pulley-transmission according to the invention, the guiding surface body features a guiding surface that is complementary to an axial face surface of the plate-link chain. In order for the guiding surface to get in contact with the outside surfaces of the extreme plate-links of the plate-link chain, the guiding surface body in the area of the pressure pieces is provided with a recess. In this exemplary embodiment of the invention, guiding surfaces can be provided on the guiding surface body above, beneath as well as above and beneath the pressure pieces.

Now in order to achieve soft run-in and thus impact-free power transmission between the pressure pieces and the guiding surface, it is provided according to a further embodiment of the invention that the guiding surface in the running direction of the plate-link chain is curved and lie with a distance between one another transversely to the running direction.

Guiding surfaces in the middle area of the longitudinal extension of the guiding surface is minimal in the running direction. In order to guarantee soft run-in, the guiding surfaces in the running direction of the plate-link chain can also be curved outwards in their respective ends and it can be straight in the middle area of the longitudinal extension of the guiding surfaces. The distance aligned transversely to the running direction between the guiding surfaces opposite one another is minimal largely in the middle area of the longitudinal extension in the running direction.

Through the curved formation of guiding surface in the running direction of the plate-link chain it is achieved that soft development of contact force between the face surfaces of pressure pieces and/or outside areas of the extreme outside plate-link chain and the guiding surface when the plate-link chain runs into the receiving area of the slide rail and therefore impact power transmission between the face surfaces of the pressure pieces and/or the outside surfaces of the extreme outside plate-link chain and the guiding surface is avoided. As soon as the so-developed axial force between the plate-link chain and the slide rail is sufficiently large to overcome unavoidable break-off torque between the slide rail and the support, the slide rail moves together with the axially displaced plate-link chain in the transverse direction to the running direction of said chain. Because the transverse distance to the running direction between the guiding surfaces opposite one another is minimum to a great extent in the middle area of the longitudinal extension of the guiding surfaces in the running direction, it is achieved that the guiding surfaces can be mounted independently of the direction of rotation and thus simple fabrication is achieved on the basis of same-part fabrication.

According to a further embodiment of the invention, it is possible that the slide surfaces transversely to the running direction of the plate-link chain feature a width larger than the width of the plate-link chain. This formation provided according to an exemplary embodiment additionally leads to the plate-link chain with the under- and top side being able to come in full surface contact on the slide surfaces.

Through the axial displaceability of the slide rail on the support according to the invention it is achieved that the overlap of the contact surfaces of the plate-link chain and the slide surfaces of the tongues is extensively retained during change of the transmission ratio of the belt and conical pulley transmission.

According to a modified exemplary embodiment in accordance with the present invention, it is provided also that the plate-link chain pressurizes the slide rail in an axial movement of a respective conical pulley so that the slide rail together with the plate-link chain experiences a movement such that the overlap of a contact surface of the plate-link chain amounts to an area of a smaller slide surface than 100 percent of the contact surface of the plate-link chain.

In order to achieve soft run-in of the plate-link chain in the receiving area of the slide rail according to the invention, it is provided according to a further embodiment that the slide surfaces are formed on the run-in side of the slide rail and are provided with a radius on the run-out side.

In the end, according to a modified exemplary embodiment also a slide rail can be provided, with which the slide surfaces of the tongues are formed differently large. Such a configuration can for example be based on the opening cone angle of the respective pair of conical pulleys on the tongue lying radially further outside, because the slide surface can thus be enlarged on this tongue lying further radially outside.

### BRIEF DESCRIPTION OF THE DRAWINGS

The invention is now illustrated as follows by means of the drawings. This features in:

FIG. 1 a sectional depiction of a belt and conical pulley transmission provided according to an embodiment of the invention;

FIG. 2 a schematic depiction of different positions of the slide rail for transmission ratio variations of the transmission according to FIG. 1;

FIG. 3 a perspective depiction of a slide rail of the belt and conical pulley transmission according to FIG. 1;

FIG. 4 a view from the bottom on the slide rail according to FIG. 3,

FIG. 5 a view on the right side of the slide rail according to FIG. 4; and

FIG. 6 a transverse section through a further exemplary embodiment of a slide rail according to the invention in the area its receptacle.

### DESCRIPTION OF THE PREFERRED EMBODIMENTS

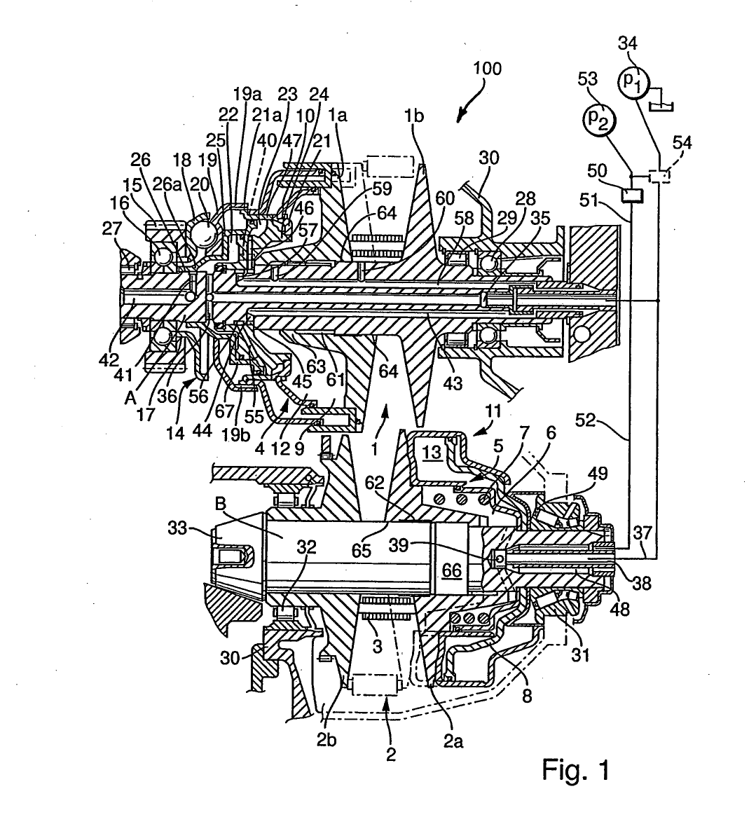

The embodiment variant of a belt and conical pulley transmission partially depicted in FIG. 1 possesses a drive-side on the drive shaft A non-rotatably disposed pair of conical pulleys, 1 and a pair of conical pulleys non-rotatably disposed on the driven-shaft B, 2. Each pair of pulleys has an axially displaceable, such as movable, pulley part, such as conical pulley, 1a and 2a and a fixed pulley part, like conical pulley, 1b and 2b. Between both pairs of pulley is a wrapping means 3, in the form of a plate-link chain, provided for torque transmission 3.

In the upper half of the respective depiction of the corresponding pair of pulleys 1, 2, the relative axial position between the corresponding conical pulley 1a, 1b and/or 2a, 2b is shown respectively, corresponds (underdrive) to the largest transmission ratio into slow speed, whereas in the lower half of these depictions the relative position is shown correspondingly assigned to conical pulley part 1a, 1b and/or 2a, 2b, that corresponds to the largest transmission ratio into the fast (overdrive) speed.

The pair of pulleys 1 can be tensioned axially via an actuator 4 that is formed as a piston-/cylinder unit. The pair of conical pulleys 2 in a similar manner can be tensioned via an actuator 5, which is formed also as a piston-/cylinder unit, axially against the chain 3. In the pressure chamber 6 of the piston-/cylinder unit 5 is an energy accumulator 7 formed by a provided coil spring pushing the axially displaceable conical pulley part 2a towards the axially fixed conical pulley part 2b. When the chain 3 on the driven-side is located in the radial internal area of the pair of pulleys 2, the applied tensioning force 7 is greater than if the chain 3 is in the larger diameter area of the pair of pulleys 2.

That means therefore that with an increasing transmission ratio of the transmission into the fast speed the tensioning force applied by the energy accumulator 7 increases. The coil spring 7 is supported on the one hand directly on the axially displaceable conical pulley part 2a and on the other hand, on a pot-shaped component 8 limiting the pressure chamber 6 and rigidly connected with the driven shaft B.

A further piston-/cylinder unit 10, 11 actively connected parallel to the piston-/cylinder units 4, 5 is respectively provided, which serve for transmission ratio change of the transmission. The pressure chambers 12, 13 of the pistons-/cylinder units 10, 11 can be filled with pressure medium or emptied alternately corresponding to the demanded transmission ratio. For this, the pressure chambers 12, 13 corresponding to the requirements can be connected either with a pressure medium source like a pump, or with a discharge line. In case of a change in transmission ratio, one of the pressure chambers 12, 13 is filled with pressure medium, thus, its volume is increased, whereas the volume of the other pressure chamber 13, 12 is at least partially emptied, thus its volume is decreased. This mutual pressurization and/or emptying of the pressure chambers 12, 13 can occur by means of an appropriate valve.

Regarding the embodiment and the functional manner of such a valve, reference is especially drawn to the already mentioned prior art. For instance, in DE-OS 40 36 683, a valve 36 formed for this purpose as a four-edged slide is provided, which is supplied by a pressure medium source 14 formed as pump.

To generate pressure that at least depends on the torque a torque sensor 14 is provided, which is based on a hydro-mechanical principle. The torque sensor 14 transmits the torque introduced via a drive gear wheel or drive pinion 15 to the pair of conical pulleys 1. The drive gear wheel 15 is supported by a roller bearing 16 on the drive shaft A and is connected non-rotatably via form closure and/or a tooth system 17 with which it is connected also axially to the cam disk 18 of the torque sensor 14 supported on the drive gear wheel 15. The torque sensor 14 possesses the axially fixed cam disk 18 and an axially displaceable cam disk 19, which have respectively run-up ramps between which spreading bodies are provided in the form of balls 20. The cam disk 19 is axially displaceable on the drive shaft A; however, it is non-rotatable relative to the latter.

For this, the cam disk 19 features a radial outer area 19a pointing axially away from the balls 20 that bears a tooth system 19b that interacts with a counter-tooth system 21 of a component 21 fixed with the drive shaft A both axially as well as circumferentially. The tooth system 19b and counter tooth system 21a are formed with reference to one other such that an axial displacement between the components 19 and 21 is possible.

The components of the torque sensor 14 limit two pressure spaces 22, 23. The pressure space 22 is limited by a ring-shaped component 24 connected rigidly with the drive shaft A as well as by the cam disk 19 and/or supported areas and/or components 25, 26. The ring-shaped component 24 is thereby secured axially by means of a safety element, with the shaft A such as drive shaft. At the same time, the element 24 can be connected non-rotatably for example with a tooth system. The ring-shaped pressure space 23 is disposed practically radially outside the ring-shaped pressure space 22, however, axially offset.

The second pressure space 23 is likewise limited by the ring-shaped component 24 as well as by the sleeve-like component 21 connected in a fixed manner with the latter and further by the cam disk 19 firmly connected with the ring-shaped component 25 that can be axially displaced and acts like a piston.

The input shaft A bearing the torque sensor 14 and the pair of conical pulleys 1 is supported on the torque sensor side by means of a needle bearing 27 and on the side facing away from the torque sensor side 14 of the pair of conical pulleys 1 it is supported via a ball bearing 28 and a roller bearing 29 provided for radial forces in a housing 30. The driven shaft B receiving the pair of driven pulleys is supported at the end neighboring the actuators 5 and 11 via a dual tapered roller bearing 31 that braces both radial forces and the axial forces occurring in both axial directions, and on the side of the pair of pulleys 2 facing away from the actuators 5, 11 it is supported by a tapered roller bearing 32 inside the housing 30. The driven shaft B carries a bevel gear wheel 33 on its end facing away from the actuators 5, 11, which is in active connection, for example, with a differential.

To produce the pressure that is at least torque-dependently modulated via the torque sensor 14, which is required for bracing the belt and conical pulley transmission, a pump 34 is provided, which is in active connection via a central channel 35 inside the drive shaft A, which flows into at least a radial channel 36, with which pressure space 22 of the torque sensor 14 is in connection. The pump 34 is further connected via a connection line 37 with the pressure chamber 6 of the piston-/cylinder unit 5 on the second pair of pulleys 2. The connection line 37 flows into a central channel 38 possible that in the driven shaft B it is again connected with the pressure chamber 6 via at least a channel 39 extending radially.

The pressure space 22 of the torque sensor 14 is connected with the pressure chamber of 9 the pistons-/cylinder unit 4 via the channel 40 that is offset in circumferential direction vis-à-vis the section in accordance with FIG. 1 and thus depicted in dashed line. The channel 40 is fitted in the annular component 24 connected with the shaft A. Via the channel 40 a connection between the first pressure space 22 and the pressure chamber 9 is therefore always available. In the drive shaft A, at least a drain channel 41 is provided furthermore, which is and/or can be brought in connection with the pressure chamber and its drainage cross-section can be changed depending at least on the transmitted torque.

The drain channel 41 flows into a central boring 42 of the shaft A that can be connected again with a line through which the oil flowing out of the torque sensor 14, for example, for the lubrication of components can be guided to an appropriate point. The axially displaceable ramps and/or cam disk 19, which are supported axially displaceably on the drive shaft A, forms a closing area with the internal area 26a which can more-or-less close the drainage channel 41 more or less depending upon at least the prevailing torque. The closing area 26a forms a valve and/or a throttle point in connection with the drain channel 41.

At least depending on the torque present between both pulleys 18,19, the drainage opening and/or drainage channel 41 is correspondingly opened or closed by means of the pulley 19 acting as control piston, by what means at least pressure generated by the pump 34 is developed at least in the pressure space 22 corresponding to the prevailing torque. Since the pressure space 22 is in connection with the pressure chamber 9 and via the channels and/or lines 35, 36, 37, 38 and 39 with the pressure chamber 6, corresponding pressure is also developed in these chambers 9, 6.

Based on parallel connection of piston-/cylinder units 4, 5 with the piston-/cylinder units 10, 11 the forces generated by the pressure supplied by the torque sensor 14 on the axially displaceable pulleys 1a, 2a are added to the forces acting on these pulleys 1a, 2a as a result of the pressures prevailing in the chambers 12, 13 for setting the transmission ratio of the transmission.

The supply with pressure medium of the pressure chamber 12 takes place via a channel 43 provided in the shaft A, which is in connection via a radial boring 44 with an annular groove 45 inside the shaft A. At least a channel 46 formed in the ring-shaped component 46 originates from the annular groove 45, which establishes connection with the radial passage 47 formed inside the sleeve-shaped component 21, which converges into the pressure chamber 12.

In a similar manner also the pressure chamber 13 is supplied with oil, thus via the channel 38 fitted inside the channel 48, which communicates with the pressure chamber 13 via radially extending connection channels 49. The channels 43 and 48 are supplied by a common pressure source via a valve 50 interposed between connection lines 51, 52. The pressure source 53 in connection with the valve 50 and/or valve system 50 can be formed by a separate pump or also by the already provided pump 34, whereby a corresponding volume and/or pressure distribution system 54 that can then comprise several valves is required. This alternative solution is depicted in dashed line.

The pressure space 23 connected actively in parallel with the pressure space 22 during pressurization in the relative position of the individual components depicted in the upper half of the pair of conical pulleys is separated from a pressure medium supply and thus, because the channels in connection with the pressure space 23 and/or borings 55, 56, 57, 58, 59, 60 are not in connection with a pressure medium source as is the case especially of the pump 34. Owing to the position of the axially displaceable pulley 1a, the radial boring 60 is opened fully so that the chamber is fully relieved in pressure. The axial force exercised because of the torque to be transmitted by the torque sensor to the cams and/or cam disk 19 is solely absorbed through the pressure oil cushion developed in the pressure space 22. At the same time the pressure occurring in the pressure space 22 is the higher the larger the torque to be transmitted is. This pressure, as already mentioned, is controlled via the areas effective as throttle valve 26a and drainage boring 41.

For transmission ratio change into fast speed, the conical pulley 1a is displaced to the right towards the conical pulley 1b. This has the effect on the pair of conical pulleys 2 that the conical pulley 2a axially moves away from the axially fixed conical pulley 2. As already mentioned, in the upper halves of the depictions of the pair of conical pulleys 1, 2 the relative positions between the pulleys 1a, 1b and 2a, 2b are depicted, which correspond to the extreme position for a transmission ratio into slow speed, whereas in the lower halves of this depictions, the relative positions between the corresponding pulleys 1a, 1b and 2a, 2b are shown, which correspond to the other extreme position of the pulleys 1a, 1b and 2a, 2b relative to each other for transmission ratio into fast speed.

In order to go from the transmission ratio shown in the upper halves of the depictions of the pair of conical pulleys 1, 2 into the transmission ratio shown in the corresponding lower halves, through appropriate control of valve 50, the pressure chamber 12 is filled accordingly and/or the pressure chamber 13 is emptied accordingly.

The axially displaceable conical pulleys 1a, 2a are coupled non-rotatably with the shaft assigned to them respectively over a connection 61, 62 by means of a tooth system. The non-rotatable connections formed by an interior tooth system on the pulleys 1a, 2a and an outside tooth system on the shafts A and B enable an axial displacement of the pulleys Ia, 2a on the corresponding shaft A, B.

The dashed position of the axially displaceable pulley 1a and of the chain 3 depicted in the upper half of the depiction of the driving pair of pulleys 1 corresponds to the highest possible transmission ratio into fast speed. The position of the chain 3 of the set of pulleys 1 drawn in dash-dotted line is assigned to the fully drawn depiction of the chain 3 of the set of pulleys 2.

The position in the lower half depiction of the driven set of pulleys 2 in the position of the axially displaceable conical pulley 2a and of the chain 3 corresponds to the largest possible transmission ratio of the transmission into slow speed. This position of the chain 3 in the upper half of the depiction of the first set of pulleys 1 is the position of the chain in depicted continuous line.

In the depicted exemplary embodiment, the pulleys 1a, 2a possess radial interior centering areas 63, 64 and/or 65, 66, through which they are either received directly on the corresponding shaft A and/or B and/or are centered. The guiding surfaces 63, 64 of the axially displaceable pulley 1a that are received practically without clearance on the jacket area the shaft A in connection with the channels 59, 60 form valves, whereby the pulley 1a serves with regard to the channels 59, 60 practically as valve slides. In case of a displacement of the pulley 1a from the position depicted in the upper half of the set of pulleys, to the right, after a certain distance, the channel 60 is gradually closed by the guiding surface 64 whilst the axial distance of the pulley 1a increases.

That means that the guiding surface 64 finally lies radially above the channel 60. In this position, also the channel 59 is closed radially outwards through the conical pulley 1a by the guiding surface 63. By continuation of the axial displacement of the pulley 1a towards pulley Ib, the channel 60 remains closed whereas pulley 1a and/or its control and/or guiding surface 63 gradually opens the channel 59. Thus, a connection between the pressure chamber 9 of the cylinder-/piston unit 4 and the channel 58 will be established via the channel 59, again by means of the channels 57, 56 and 55 a connection to the pressure space 23 is established.

Because the channel 60 is practically closed and now a connection between the pressure chamber 9 and the two pressure spaces 22 and 23 is available, the same pressure adjusts practically between the pressure spaces 22, 23 and in the pressure chamber 9 and therefore also in the chamber 6 connected via the channel 35 and lines 37, 38 in an active manner apart from the small losses possibly available in the transmission path. Through the transmission-ratio dependent connection between both pressure spaces 22 and 23 is the axially effective area of the pressure medium cushion available in the torque sensor 14, because the axially effective areas of both pressure spaces 22, 23 are added together in effect. This enlargement of the axially effective support surface has the effect that based on the same torque of the pressure developed by the torque sensor; it is practically reduced proportionally to the area increase, what again means that also in the pressure chambers 9 and 6 a correspondingly reduced pressure acts. In addition, torque-dependent modulation of the pressure superimposed with transmission-ratio dependent modulation of pressure can be generated by means of the torque sensor 14.

The depicted torque sensor 14 enables practically a two-stage modulation of the pressure and/or of the pressure level.

In the depicted exemplary embodiment, both channels 59, 60 in relation to each other and to the areas 63, 64 of the pulley 1a interacting with them are disposed and/or formed such that switchover from the one pressure space 22 to the two pressure spaces 22 and 23 and vice versa occurs for a transmission ratio of approx. 1:1 of the belt and conical pulley transmission. As already indicated, such a switchover cannot occur abruptly based on the design version so that a transition area is provided, with which the drain channel 60 is closed already, the connection channel 59, however, still does not feature a connection with the pressure chamber 9. In order to guarantee in this transition area the function of the transmission and/or of the torque sensor 14, for which an axial displacement possibility of the cam disk 19 must be guaranteed, balance means are provided, which enable a volume change of the pressure space 23, so that the torque sensor 14 can pump, what which means that the cylinder and piston components of the torque sensor 14 can move axially to each other.

In the depicted exemplary embodiment, these balance means are formed by a tongue- and/or lip seal 67 that is accommodated in a radial groove of the ring-shaped component 24 and it cooperates with the internal cylinder area of the component 25, in order to seal both pressure spaces 22, 23 relative to one another. The sealing ring 67 is formed and disposed such that it is only blocked in an axial direction and/or prevents pressure balance between both chambers 22 and 23 whereas in the other axial direction at least in the presence of a positive differential pressure between the pressure space 23 and the pressure space 22 a pressure balance and/or a flow through the seal ring 67 is possible. The sealing ring 67 acts gradually like a non-return valve, whereby flow from the pressure space 22 is prevented into the pressure space 23, however, flow is possible through the sealing point formed by the sealing ring 67 when a certain excess pressure in pressure space 23 relative to the pressure space 22 is exceeded.

When the cam disk 19 moves to the right, the pressure fluid can flow from the closed pressure space 23 to the space 22. In a subsequent motion of the cam disk 19 to the left, a low pressure can occur in the pressure space 23 and air bubbles can form in oil where applicable. This is not harmful, however, for the function of the torque sensor and/or of the belt and conical pulley transmission.

Instead of the non-return valve-like acting seal 67, a non-return valve could also be provided between both pressure spaces 22, 23 that would be installed in the ring-shaped component 24. A seal 67 effective in both axial directions could then be used. Furthermore, such a non-return valve could also be disposed such that it acts between both channels 35 and 58. The non-return valve must be disposed at the same time such that a volume flow from the pressure space 23 is possible towards the pressure space 22, in the reverse direction, however, the non-return valve blocks.

From the preceding function description, it follows that practically over the entire partial area of the transmission ratio range in which the transmission occurs into slow speed (underdrive), which through the axial force developed by the ball ramps provided on the pulleys 18, 19 only axially effective surface formed by the pressure space 22 is supported, whereas practically over the entire partial area of the transmission ratio in which the transmission occurs into fast speed (overdrive), the axial force produced by the ball ramps on the pulley 19 is absorbed by both axially effective areas of the pressure spaces 22, 23. Therefore, based on the same input torque for a transmission into slow speed, the pressure developed by the torque sensor is higher than that generated by the torque sensor 14 for a transmission ratio into fast speed. As already mentioned, the depicted transmission is designed such that the switch-over point of the one connection or separation between the two pressure spaces 22, 23 is effected in a transmission ratio range of approx. 1:1. Through a corresponding disposition and embodiment of the channels 59, 60 and the areas 63, 64 interacting with the latter, the conical pulley 1a, however, can displace the switchover point accordingly and/or switchover within the entire transmission ratio of the conical pulley transmission.

The connection and/or separation between both pressure spaces 22, 23 can also occur via a valve provided especially for this, in that one of both pressure spaces 22, 23 can be disposed in the area of the connecting channel, whereby this valve must additionally not be actuated directly above the pulley 1a or 2a, but, for example, be actuated via an energy source. For this, for example, an electromagnetically, hydraulically or pneumatically actuatable valve can find application, which is switchable, depending on transmission ratio change.

For example, a 3-/2-valve can find application, which effects a connection or separation between both pressure spaces 22, 23. However, also pressure valves can find application. A corresponding valve could not be provided in one of the channels 35 and 58 connecting line whereby both channels 59 and 60 are then closed and/or not available. The corresponding valve is connected such that for divided pressure spaces 22, 23 of the pressure space 23, pressure is relieved via the valve. For this, the valve can be connected with a line leading into the oil sump.

When using a valve controllable from outside, this can also still be actuatable depending on other parameters. For instance, this valve can be actuatable for example also in dependence on torque impacts occurring in the drive. In this way, for instance, the chain can at least slide through in certain operation conditions and/or transmission ratios of the conical pulley transmission can be avoided and/or reduced at least.

In the design depicted in FIG. 1, the torque sensor 14 is disposed on the drive side and next to the axially displaceable conical pulley 1a. The torque sensor 14 can be provided, however, in the torque flow to any space and it can be adapted accordingly. As such, a torque sensor 14 can be provided as already known, also on the driven side, for example on the driven-shaft B. Such a torque sensor, in a similar manner as the torque sensor 14, can be disposed next to the axially displaceable conical pulley 2a. Also as already known, several torque sensors can find application. For example, both on the drive side as well as on the driven side, a corresponding torque sensor can be disposed.

In addition, the torque sensor 14 with at least two pressure spaces 22, 23 can be combined with other measures for torque dependent and/or transmission-ratio-dependent pressure modulation. For instance, the rolling bodies 20, in similarity with the description in DE-OS 42 34 294, could be displaceable depending on a transmission ratio change in radial direction along the rolling ramps and/or rolling surfaces interacting with the latter.

In the described exemplary embodiment in accordance with FIG. 1, the pressure chamber 6 is connected with the torque sensor 14. It is possible also, to pressurize the external pressure chamber 13 with the pressure delivered by the torque sensor 14, whereby then the internal pressure chamber 6 serves for the transmission ratio change. For this, it is solely required to exchange the connections of the two lines 52 and 37 on the second set of pulleys 2 alternately and/or with one another.

In the exemplary embodiment of the torque sensor 14 in accordance with FIG. 1, the forming parts are mostly made of sheet metal. Particularly, the cam disks 18 and 19 can be produced as a sheet metal form part, for example, through stamping.

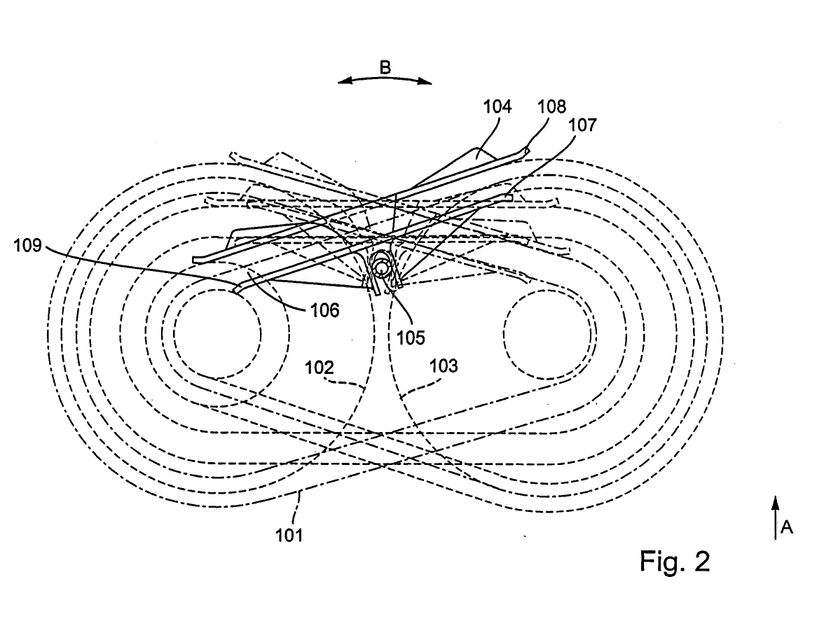

FIG. 2 of the drawings shows different shapes by means of dash-dotted depictions of the plate-link chain 101, which adjust themselves upon changes of the transmission ratio of the belt and conical pulley transmission 100 according to FIG. 1. These transmission ratio variations will adjust through axial shifting of the respectively axially displaceable conical pulley 102 or 103. These transmission ratio variations lead to a displacement of the slide rail 104 on the support 105 towards the arrow A and to a tilt movement on the support 105 towards the arrow B.

The slide rail 104 at the same time has a receiving area 106 that is formed between two tongues spaced apart, namely a first tongue 107 and a second tongue 108.

On the two tongues 107, 108, slide surfaces 109 are formed, on which the plate-link chain 101 can slide with its top side and underside, so that transverse oscillations of the plate-link chain 101, thus oscillation transversely to the running direction, can be avoided.

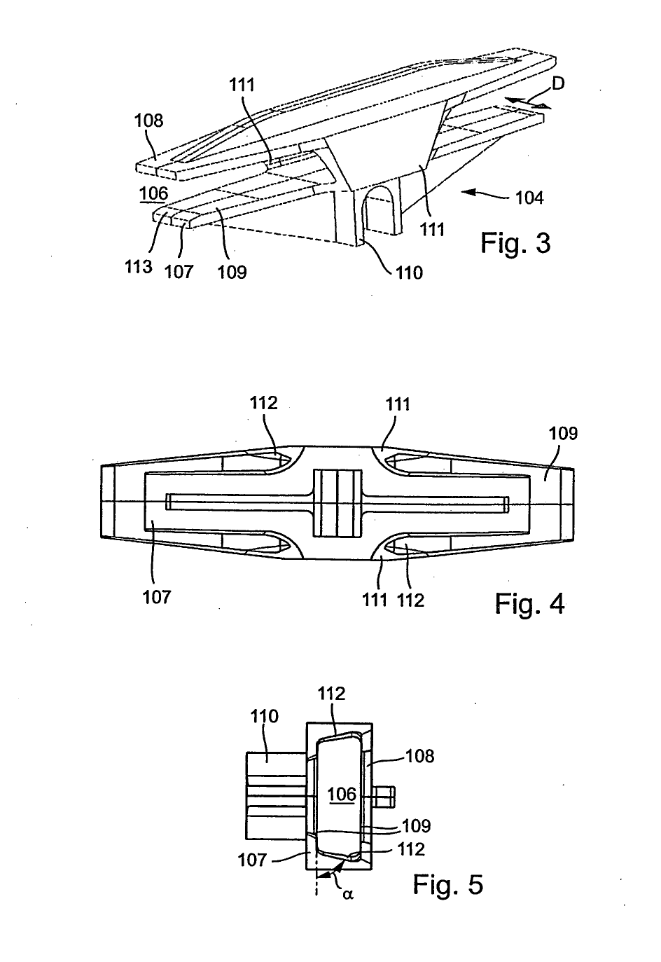

FIG. 3 of the drawings features a perspective view of an exemplary embodiment of the slide rail 104.

As obviously evident, the slide rail 104 possesses a U-shaped receiving area 110, by means of which the slide rail 104 on the support 105 depicted on FIG. 2 of the drawing in form of a pipe piece disposed between the conical pulleys 102 and 103 and thus the mobility of the slide rail 104 clarified relatively in the drawing of the support 105 is provided for, and in addition, the slide rail 104 can also be displaced relatively to the support 105, in that this can execute a relative movement on the support 105 out of the plane of the drawing of FIG. 2, thus it can be displaced axially on the support 105.

If a transmission ratio variation is carried out namely with the belt and conical pulley transmission 100, then this leads to an axial displacement of the respectively displaceable conical pulley 102 or 103 relative to the fixed conical pulley.

This axial displacement movement leads to a corresponding displacement movement of the plate-link chain 101 from the drawing plane of FIG. 2 from or into the latter, thus perpendicularly to the drawing plane of FIG. 2.

The slide rail 104 is now disposed with its receptacle 110 on the support 105 axially displaceably, thus on the support 105 there are no fastening means with which the receptacle 110 of the slide rail 104 is fixed axially on the support 105, but rather the projecting described displacement movement of the plate-link chain 101 transversely to its circulation direction according to FIG. 2 leads to a movement of the plate-link chain 101 in the receiving area 106 of the slide rail 104 in accordance with the double arrow D according to FIG. 3.

In its circulation movement, the plate-link chain 101 with its underside slides on the slide surface 109 of the first tongue 107 and with its top side on the slide surface 109 of the second tongue 108.

In the disposition of the slide rail 104 depicted in FIG. 2 of the drawing, this receives the tight-side of the plate-link chain 101 in the receiving area 106 so that transverse wrappings of the plate-link chain 101 by the contact between the plate-link chain and the slide surfaces 109 of the lower tongue 107 as well as the upper tongue 108 are avoided.

If now the transmission ratio change of the belt and conical pulley transmission 100 comes to a displacement movement of the plate-link chain 101 towards the double arrow D according to FIG. 3, then the pressure pieces (not more closely depicted) of the plate-link chain 101 do not come in contact with the respectively formed guiding surface bodies 111 on the first tongue or lower tongue 107 and the second tongue and/or top tongue 108, respectively. This means, in other words, that the largely perpendicular guiding surface bodies 111 formed on the first and second tongues feature guiding surfaces 112 on which the pressure pieces of the plate-link chain 101 come to rest such that between the pressure pieces and the guiding surfaces 112 an axial force is developed, which provides that the slide rail 104 with its receptacle 110 on the support 105 is displaced toward the axis of the support 105 and therefore in this axial movement towards the double arrow D according to FIG. 3 of the contact surface between the underside of the plate-link chain 101 and/or the top side of the plate-link chain 101 are retained with the respective slide surfaces 109 of the lower and upper tongue 107, 108.

As is evident based on FIG. 4 of the drawing, the guiding surface 112 on the guiding surface body 111 is curved. It means, in other words, that in the run-in of the plate-link chain 101 in the receiving areas 106 a contact between the face surfaces of the pressure pieces of the plate-link chain 101 and the guiding surfaces 112 takes place, that is extensively free of an impact impulse, and leads to a slow development of a normal force between the pressure pieces and the guiding surfaces for so long until the slide rail 104 with its receptacle 110 moves axially on the support 105, and thus, the movement of the slide rail 104 towards the axis of the support 105 with the corresponding movement of the plate-link chain 101 towards the axis of this support 105 corresponds.

As FIG. 4 of the drawings closely features, the first tongue 107 with respect to its flat extension is formed smaller than the second tongue 108. This results, based on the cone angle of the conical pulleys 102 and 103, because the first tongue 107 passes more closely to the respective conical pulleys than the second tongue 108 lying outside.

As FIG. 5 of the drawings features closely, the respective guiding surface 112 in the angle on the slide surface 109 whereby this angle corresponds largely to an angle α formed on the face surface of the pressure pieces (not depicted more closely) depicted of the plate-link chain, so that in the run-in of the pressure pieces of the plate-link chain 101 in the receiving area 106 of the slide rail 104 gradual development and more softly normal force development between the pressure pieces and the respective guiding surface 112, up to the slide rail 104 with its receptacle 110 on the support 105 executes an axial displacement movement and thus the movement of the plate-link chain 101 in the direction of the double arrow D according to FIG. 3, thus transversely to the circulation direction of the plate-link chain 101 follows.

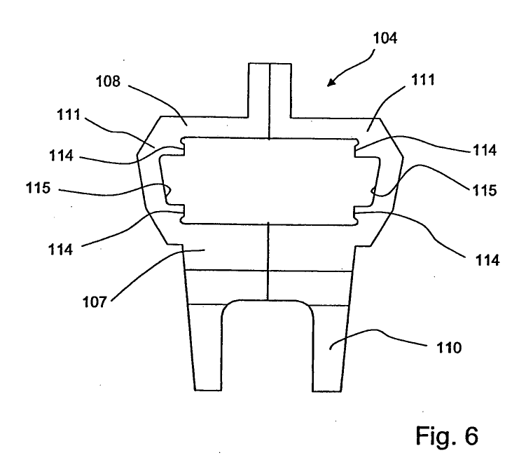

FIG. 6 is a sectional depiction in the area of the receptacle 110 transversely through the slide rail 104. As in the exemplary embodiment according to FIGS. 3 to 5, the slide rail 104 likewise features a first tongue 107 and a second tongue 108. On the two-sided guiding surface bodies 111, four guiding surfaces 114 are formed, which however touch the outwardly-facing surfaces of the chain links (not shown here). Between the upper and lower guiding surfaces, a recess 115 is introduced in each of both guiding surface bodies 111 that are formed large, but which are formed so large that they carry the pressure pieces of the chain link without touching the guiding surface bodies 111. In the transition areas between the slide surfaces of the tongues 107 and 108 and the guiding surfaces 114, radii and/or undercuts can be provided.

In the exemplary embodiments depicted in FIGS. 3 to 6 of the slide rail 104 according to this invention they consist of two halves. The slide rail, as can be seen on middle dividing joints, is divided in the longitudinal extension direction of the plate-link chain. Both parts, which can be supplemented by further components, for example, consist of an injection-cast plastic and they can be put together by means of clip connections. Obviously, also other materials and connection methods are applicable.

As is evident on the basis of FIG. 3 of the drawings, the slide surfaces 109 on the lower tongue 107 and on the upper tongue 108 respectively on the run-in side and run-out side is provided with a radius 113 that provides that when the plate-link chain 101 runs in the receiving area 106 a smooth run-up of the underside and top side of the plate-link chain 101 in the receiving area 106 occurs between both slide surfaces 109 of the slide rail 104.

Since the slide rail 104 follows the axial displacement movement of the plate-link chain 101 for the change of the transmission ratio of the belt and conical pulley transmission 100, the contact surface between the underside and top side of the plate-link chain 101 and the slide surfaces 109 on the slide rail 104 during the complete transmission ratio change of the belt and conical pulley transmission 100 according to the present invention remains free. This additionally leads to the surface pressures between the top and the underside of the plate-link chain 101 and the slide surfaces 109 of the slide rail 104 not changing during the transmission ratio change, thus, a uniform load of the slide surfaces is provided for and the wear problem on the slide surfaces is eliminated.

With respect to the above features of the invention not clarified more closely, reference is drawn expressly to the claims and drawings.

1. A belt and conical pulley transmission comprising: a drive-side and a driven-side pair of conical pulleys with respectively an axially displaceable and an axially fixed conical pulley; a plate-link chain including pressure pieces and disposed between the pairs of conical pulleys for torque transmission between the pairs of pulleys; a slide rail for guiding the plate-link chain and tiltably carried on a support for tilting movement about an axial direction of the support, wherein the slide rail has a pair of substantially parallel slide surfaces defined by spaced first and second tongues to form a chain receiving area for slidably receiving the plate-link chain, and wherein the slide rail is axially displaceably disposed on the support.

2. The belt and conical pulley transmission according to claim 1, wherein the slide rail is axially displaceable along the support by the plate-link chain.

3. The belt and conical pulley transmission according to claim 1, wherein the first and second tongues are spaced from each other by a pair of laterally spaced guiding surface bodies extending perpendicularly to the slide surfaces, which guiding surface bodies contact the plate-link chain so that a contact force between the plate-link chain and a guiding surface body leads to displacement of the slide rail axially along the support.

4. The belt and conical pulley transmission according to claim 3, wherein the guiding surface bodies each include inclined chain guiding surfaces that are formed on the guiding surface bodies and are inclined to conform with angularly inclined axial end face surfaces of the chain pressure pieces.

5. The belt and conical pulley transmission according to claim 4, wherein the guiding surfaces are angularly inclined relative to the slide surfaces.

6. The belt and conical pulley transmission according to claim 3, wherein a chain link guiding surface formed on a guiding surface body is complementary to outer side surfaces of chain link plates, and wherein the chain link guiding surface region opposite to end faces of the pressure pieces is includes a recess.

7. The belt and conical pulley transmission according to claim 6, wherein two chain link guiding surfaces formed on a guiding surface body are complementary to outer side surfaces of the chain link plates.

8. The belt and conical pulley transmission according to claim 4, wherein the guiding surface extends in the running direction of the plate-link chain and is curved, and a distance transverse to the chain running direction between opposed guiding surfaces in a middle region of the longitudinal extension of the guiding surfaces in the chain running direction is a minimum.

9. The belt and conical pulley transmission according to claim 4, wherein the guiding surface in the running direction of the plate-link chain is curved at its respective longitudinally outer ends, and in a middle region of the longitudinal extension the guiding surface and a distance transverse to the chain running direction between opposed guiding surfaces in the middle region of the longitudinal extension of the guiding surface in the chain running direction is a minimum.

10. The belt and conical pulley transmission according to claim 1, wherein the slide surfaces extend transversely to the running direction of the plate-link chain at a width that is greater than the width of the plate-link chain.

11. The belt and conical pulley transmission according to claim 1, wherein an overlap of contact surfaces of the plate-link chain and the slide surfaces of the tongues remains constant during a change of the transmission ratio of the belt and conical pulley transmission.

12. The belt and conical pulley transmission according to claim 1, wherein the plate-link chain exerts pressure on the slide rail during an axial displacement of a respective conical pulley and with a force such that the slide rail moves together with the plate-link chain, wherein an overlap of a contact surface of the plate-link chain with a smaller slide surface area amounts to largely 100 percent of the contact surface of the plate-link chain.

13. The belt and conical pulley transmission according to claim 1, wherein the slide surfaces on a chain run-in side and a chain run-out side are formed with a radius.

14. The belt and conical pulley transmission according to claim 1, wherein the slide surfaces on the tongues are different in size.
